(19) United States
(12) Patent Application Publication
(10) Pub. No.: US 2019/0227313 A1
(43) Pub. Date: Jul. 25, 2019

(54) HEAD-UP DISPLAY WITH A SEGMENTED COVER

(71) Applicant: VISTEON GLOBAL TECHNOLOGIES, INC., Van Buren Township, MI (US)

(72) Inventors: YVES LAMBERT, JOUY-LE-MOUTIER (FR); MICHAEL AUTISSIER, GENICOURT (FR); SEBASTIEN HERVY, LAINCOURT ST PIERRE (FR)

(21) Appl. No.: 15/877,850

(22) Filed: Jan. 23, 2018

(51) Int. Cl. G02B 27/01

(52) U.S. Cl. CPC G02B 27/0149; B60K 35/00; G02B 2027/015; G02B 2027/0154

(57) ABSTRACT

A head-up display unit having a segmented cover includes a housing having an upper surface defining an aperture to an interior space and holding a combiner. The combiner is movable between a storage position within the housing and an operational position extending through the aperture. The segmented cover is movable between a closed position covering the aperture and an opened position uncovering the aperture. The segmented cover includes a plurality of flaps of rigid material, each having a generally rectangular elongated profile and arranged adjacent and parallel to one another. The segmented cover also includes a flexible connection between adjacent ones one of the flaps to allow the segmented cover to be rolled cylindrically into the opened position. The flexible connection includes flexible material overmolded on the flaps in one or more different configurations. A method of constructing the segmented cover for a head-up display unit is also provided.

### BACKGROUND

It is known from the state of the art how to project information in the field of sight of a user, such as, for example, a driver or a pilot, by means of a head-up display, or HUD.

One common arrangement of a HUD employs a combiner to merge a background image with a projected image to present a virtual image to a viewer that appears to overlie the background image. Such combiners are commonly movable to adjust the position of the virtual image and to accommodate, for example, viewers of different heights, HUDS also commonly provide for the combiner to be moved to a storage position when not in use, and for a cover to enclose the combiner in the storage position. In this way, the combiner can be protected from damage, such as from dust and UV light that could otherwise cause damage. Covers for head-up displays generally comprise one or two pieces that slide or rotate into position over the combiner. Such covers must usually be custom designed for each HUD application (e.g. different shapes and sizes for different vehicles). They require a relatively large amount of space to store and a relatively large amount of free space to accommodate motion between the different positions, covering or uncovering the combiner.

Furthermore, head-up display covers must accommodate several different operational parameters and considerations including ease of manufacturing, gaps between components, noise (i.e. resistance to vibrations), and the ability to withstand misuse loads, such as weight being placed upon the cover.

### SUMMARY

A head-up display unit having a segmented cover is disclosed. The head-up display unit includes a housing having an upper surface defining an aperture to an interior space and holding a combiner. The segmented cover is movable between a closed position covering the aperture and an opened position uncovering the aperture to allow the combiner to protrude therethrough. The combiner may be movable between a storage position within the housing and an operational position extending through the aperture.

The segmented cover includes a plurality of flaps of rigid material, each having a generally rectangular elongated profile and a generally rectangular cross-section. The flaps are disposed adjacent to one another with the elongated profiles running in parallel. A flexible connection extends between adjacent ones of the flaps to allow the segmented cover to be rolled cylindrically into the opened position. The flaps of the segmented cover define an inner surface facing the interior space of the housing with the segmented cover in the closed position. The flaps also have an outer surface opposite the inner surface. The inner surface each of the plurality of flaps may include a rib extending transversely therefrom. The ribs may be integrally formed with the flaps of rigid material.

In one example embodiment, the flexible connection includes a first layer of flexible material affixed to the outer surface of the flaps and defining a smooth exterior surface of the segmented cover. The first layer of flexible material may be overmolded onto the outer surface of the flaps.

In another example embodiment, the flexible connection includes a second layer of flexible material affixed to the inner surface of the flaps. The second layer of flexible material may be overmolded onto the inner surface of the flaps.

In yet another example embodiment, the flexible connection includes a webbing of flexible material affixed between adjacent ones of the flaps. The webbing of flexible material may be overmolded between adjacent ones of the flaps of the segmented cover. The webbing of flexible material may not contact the inner surface or the outer surface of the flaps.

An opening mechanism may be included to move the segmented cover from the closed position to the opened position. The opening mechanism may include a first spool attached to a first end of the segmented cover for pulling the segmented cover to the opened position.

A closing mechanism may be included to move the segmented cover to the closed position. The closing mechanism may include a second spool attached to a second end of the segmented cover for pulling the segmented cover to the opened position.

The head-up display unit having a segmented cover of the subject disclosure provides for several advantages over head-up display units of the prior art. It provides fix a reduced packaging size and for improved ability to withstand misuse force, to minimize gaps, and to prevent noise from vibrations. Furthermore, it can be more easily adapted to different configurations for different applications by, for example, using more or fewer flaps or by changing the shape of an overmolding, while keeping functional mechanical changes to a minimum.

A method of constructing a segmented cover for a head-up display unit is also provided. The method includes the steps of molding a plurality of flaps of a rigid material, with each of the flaps having a generally rectangular elongated shape; aligning the plurality of flaps parallel to one another; overmolding a flexible material on the plurality of flaps to form a flexible connection between adjacent ones of the flaps; removing the plurality of flaps from the overmolding as a segmented cover; and mounting the segmented cover to a housing of the head-up display unit.

According to an aspect, the step of overmolding a flexible material on the plurality of flaps to form a flexible connection between adjacent ones of the flaps may also include affixing the flexible material on the outer surface of the flaps. This aspect is illustrated in the embodiment of FIG. 6.

According to an another aspect, the step of overmolding a flexible material on the plurality of flaps to form a flexible connection between adjacent ones of the flaps may further include affixing the flexible material on the inner surface of the flaps. The step of overmolding a flexible material on the plurality of flaps to form a flexible connection between adjacent ones of the flaps may also include affixing the flexible material on the inner surface of the flaps and between the ribs thereof. This aspect is illustrated in the embodiment of FIG. 7.

According to yet another aspect, the step of overmolding a flexible material on the plurality of flaps to form a flexible connection between adjacent ones of the flaps may include affixing the flexible material between the sides of the flaps. This aspect is illustrated in the embodiment of FIG. 8.

### BRIEF DESCRIPTION OF THE DRAWINGS

Further details, features and advantages of designs of the invention result from the following description of embodiment examples in reference to the associated drawings.

FIG. 1 is a cut-away side view of a head-up display unit with a combiner in a storage position;

FIG. 2 is a cut-away side view of the head-up display unit of FIG. 1 with the combiner in an operational position;

FIG. 3 is a top view of a segmented cover for the head-up display unit;

FIG. 4 is a cut-away side view of the segmented cover of FIG. 3 along the line 4-4;

FIG. 5 is a cut-away side view of a segmented cover in a partially rolled-up configuration;

FIG. 6 is a cut-away side view of an embodiment of a segmented cover including a first layer of flexible material;

FIG. 7 is a cut-away side view of another embodiment of a segmented cover including a second layer of flexible material;

FIG. 8 is a cut-away side view of yet another embodiment of a segmented cover including a webbing of flexible material; and

FIG. 9 is a flow chart illustrating a method of constructing a segmented cover for a head-up display.

### DETAILED DESCRIPTION

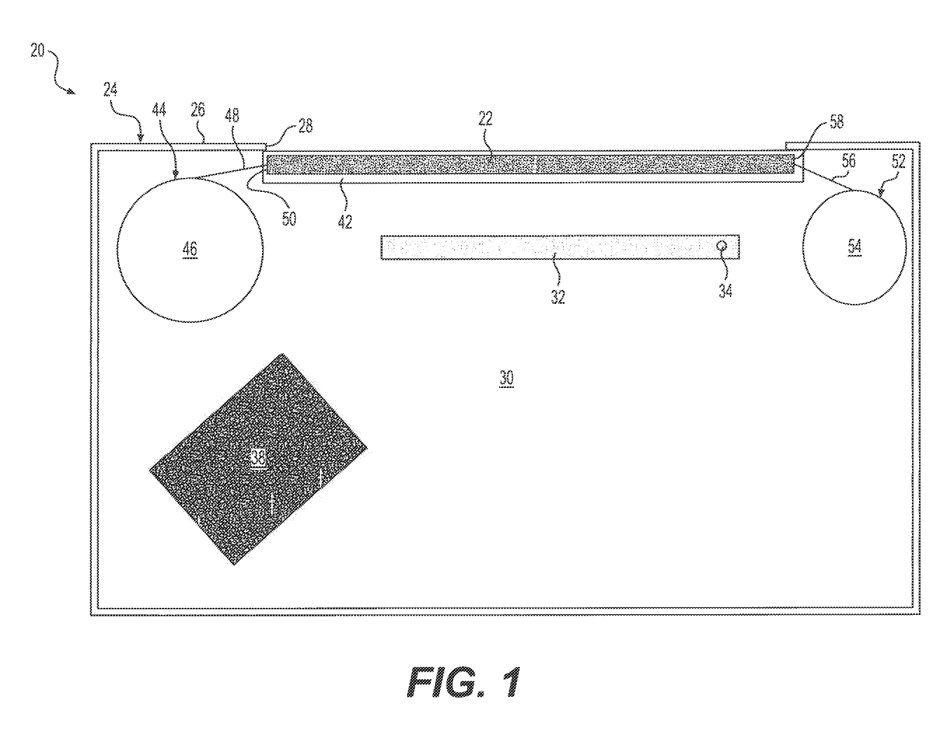

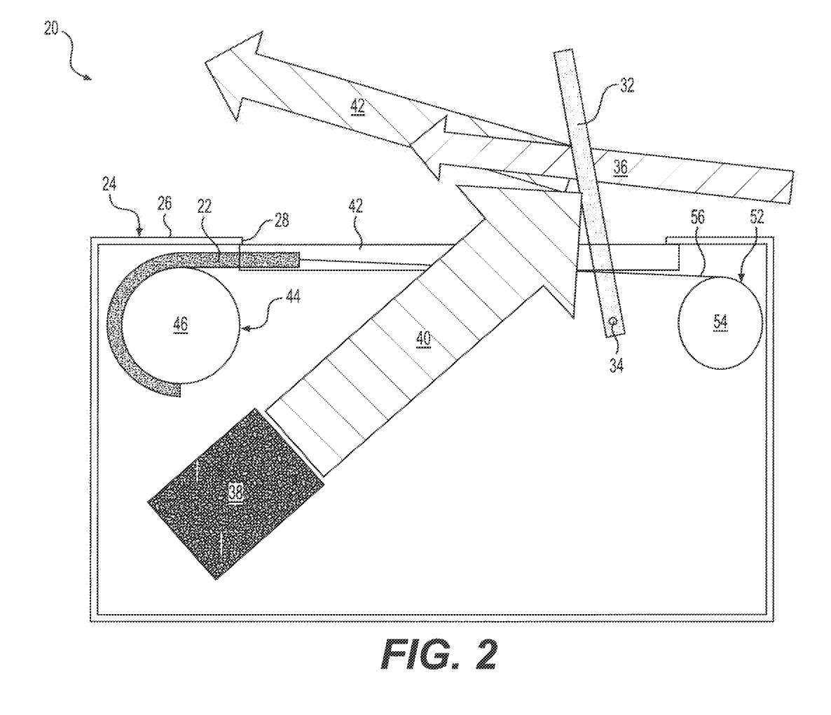

Referring to the Figures, wherein like numerals indicate corresponding parts throughout the several views, a head-up display unit 20 having a segmented cover 22 is disclosed. As shown in the cut-away views of FIGS. 1 and 2, the head-up display unit 20 includes a housing 24 having an upper surface 26 defining an aperture 28 to an interior space 30 and holding a combiner 32.

The combiner 32 is movable between a storage position within the housing 24, as shown in FIG. 1, and an operational position extending through the aperture 28, as shown in FIG. 2. The combiner 32 is movable by rotating about a pivot 34. As best shown in FIG. 2, the combiner 32 is transmissive to a first light beam 36, so the first light beam 36 may pass therethrough in order to present a background image to a viewer. In vehicular applications, this background image may be, for example, the roadway in front of the viewer who is the driver of the vehicle.

As shown in FIG. 2, the head-up display unit 20 also includes a picture generating unit 38 to project a second light beam 40 upon the combiner 32 with the combiner 32 in the operational position. The combiner 32 reflects the second light beam 40 as a third light beam, and thereby presents a virtual image to the viewer, with the virtual image superimposed over the background image. The virtual image may include, for example, instrument data regarding the vehicle such as speed, RPM, and/or battery status. The virtual image may be used to present other information to the viewer such as, for example, navigation instructions, infotainment data, or communications messages.

The segmented cover 22 is movable by sliding along a track 42 between a closed position covering the aperture 28, as shown in FIG. 1, and an opened position uncovering the aperture 28 to allow the combiner 32 to protrude therethrough, as shown in FIG. 2.

As best shown in FIGS. 1-2, the head-up display unit 20 also includes an opening mechanism 44 including a first spool 46 for pulling the segmented cover 22 from the closed position to the opened position using a first cable 48 attached to a first end 50 of the segmented cover 22. The opening mechanism 44 may function to move the segmented cover 22 from any intermediate position between the opened and closed positions into the opened position. The head-up display unit 20 also includes a dosing mechanism 52 including a second spool 54 for pulling the segmented cover 22 from the opened position to the closed position using a second cable 56 attached to a second end 58 of the segmented cover 22. The closing mechanism 52 may function to move the segmented cover 22 from any intermediate position between the opened and closed positions into the closed position. Other devices may be used in the closing mechanism 52 in addition to or instead of the second spool 54. Such other devices may include, for example, gears or levers to move the segmented cover 22 to the closed position. The closing mechanism 52 may be driven, such as by a motor or by a spring. The closing mechanism 52 may be mechanically coupled to the opening mechanism 44 to operate together. The closing mechanism 52 may be configured to move the segmented cover 22 to the closed position in the absence of power such as, for example, by using a spring. The opening mechanism 44 and the closing mechanisms 52 may be combined into a single mechanism that operates to move the segmented cover 22 in either of two different directions by, for example, pushing or pulling the segmented cover 22 in either of two opposite directions.

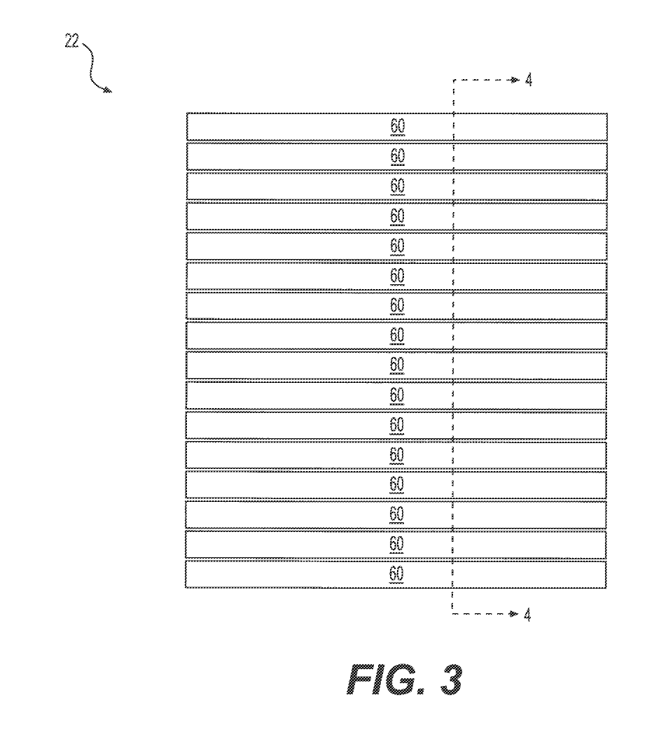

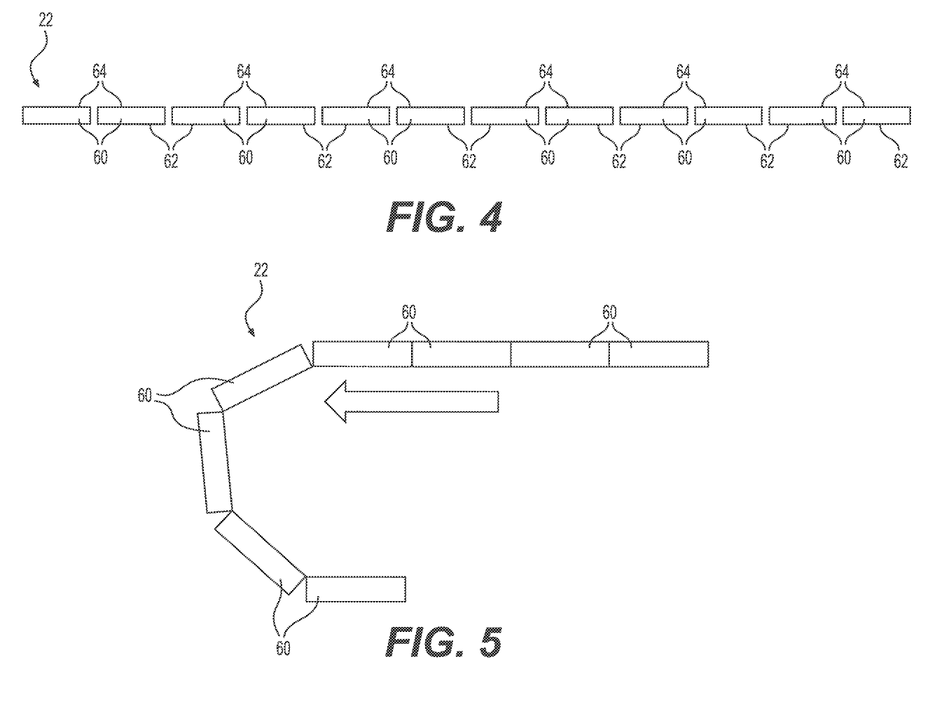

The segmented cover 22 includes a plurality of flaps 60 of rigid material. As best shown in FIG. 3, each of the flaps 60 has a generally rectangular elongated profile and are arranged adjacent and parallel to one another in a rectangular planar arrangement when the segmented cover 22 is in the closed position. As best shown in FIG. 3, each of the flaps 60 has a generally rectangular cross-section including an inner surface 62 that faces the interior space 30 of the housing 24 with the segmented cover 22 in the closed position. Each of the flaps 60 also includes an outer surface 64 opposite the inner surface 62. There may be gaps between adjacent ones of the flaps 60 as shown in FIG. 4. Alternatively, the flaps 60 may abut one another as shown in FIG. 5.

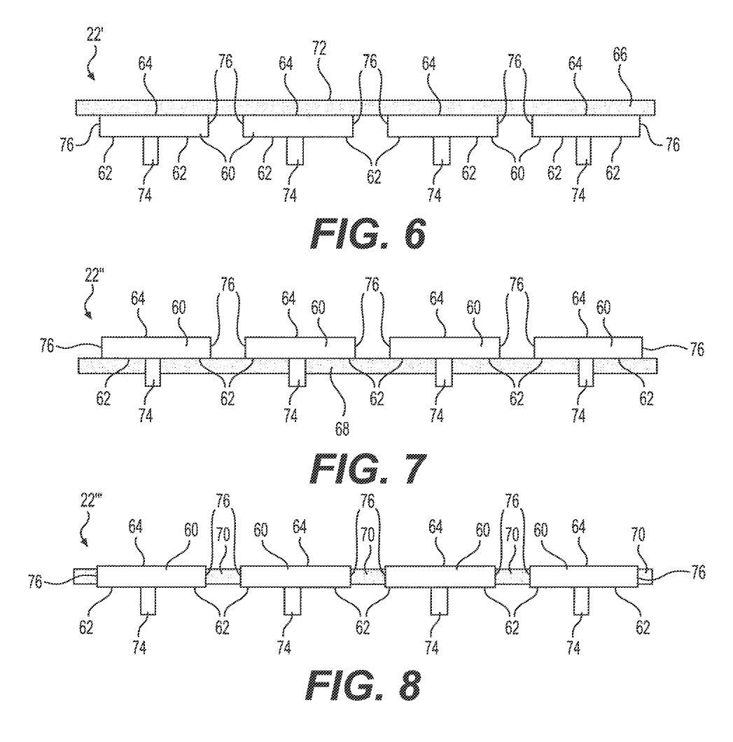

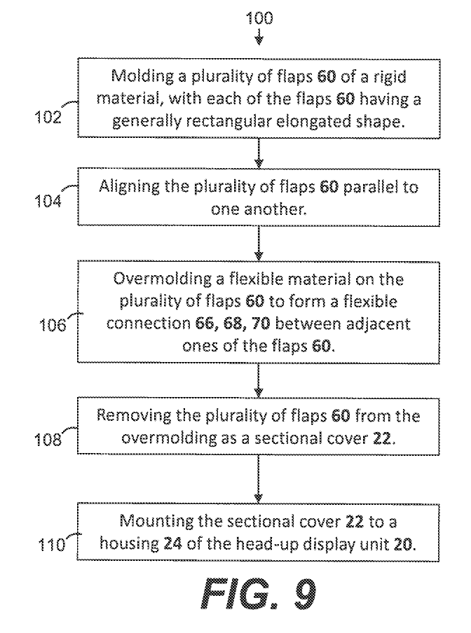

As shown in FIGS. 6-8, the segmented cover 22 may take one of several different variations 22′, 22″, 22′″, with each of the variations 22′, 22″, 22′″ of the segmented cover 22 including a flexible connection 66, 68, 70 between adjacent ones one of the flaps 60 to allow the segmented cover 22 to be rolled cylindrically into the opened position. In other words, the flexible connection 66, 68, 70 binds the flaps 60 together to form the segmented cover 22, with the segmented cover 22 being flexible in one direction, but rigid in other directions.

In the embodiment shown in FIG. 6, the flexible connection 66, 68, 70 includes a first layer 66 of flexible material affixed to the outer surface 64 of the flaps 60 and defining a smooth exterior surface 72 of the segmented cover 22′. That smooth exterior surface 72 may include texturing and/or any one of several different finishes such as glossy, matte, shiny, etc. According to an aspect, the first layer 66 of flexible material may be overmolded onto the outer surface 64 of the flaps 60.

In the embodiment shown in FIG. 7, the flexible connection 66, 68, 70 includes second layer 68 of flexible material affixed to the inner surface 62 of the flaps 60 of the segmented cover 22″. According to an aspect, the second layer 68 of flexible material may be overmolded onto the inner surface 62 of the flaps 60. As also shown in FIG. 7, the inner surface 62 each of the plurality of flaps 60 may include a rib 74 extending transversely therefrom. Each rib 74 may extend for part or all of the length of the flap 60 and may be continuous or interrupted. The rib 74 may function to provide additional rigidity to the flaps 60 and/or to provide additional anchoring strength for holding the flaps 60 together with the second layer 68 of flexible material. According to an aspect, the ribs 74 may be integrally formed with the flaps 60 of rigid material such as, for example, by being molded together of the same material. The rigidity of the flaps 60 provides the segmented cover 22 with strength to withstand misuse such as, for example, placement of predetermined amounts of weight on the segmented cover 22.

In the embodiment shown in FIG. 8, the flexible connection 66, 68, 70 includes a webbing 70 of flexible material affixed between adjacent ones of the flaps 60 of the segmented cover 22′″. According to an aspect, the webbing 70 of flexible material may be overmolded between adjacent ones of the flaps 60. As shown in FIG. 8, the webbing 70 of flexible material may not contact the inner surface 62 or the outer surface 64 of the flaps 60. Alternatively, the webbing 70 of flexible material may extend above and/or below the flaps 60 and may contact one or both of the inner surface 62 or the outer surface 64 of the flaps 60. In other words, the webbing 70 may also include one or both of the first layer 66 and/or the second layer 68 of flexible material.

A method 100 of constructing a segmented cover 22 for a head-up display unit 20 is also provided. The method 100 includes 102 molding a plurality of flaps 60 of a rigid material, with each of the flaps 60 having a generally rectangular elongated shape. The flaps 60 are preferably molded from a plastic or thermoplastic material, although other materials such as metal or wood may be used.

The method 100 also includes 104 aligning the plurality of flaps 60 parallel to one another. In other words, placing the flaps 60 in alignment as shown in FIGS, 3 and 4, with the longest dimension being parallel to the longest dimension of the other flaps 60.

The method 100 may also include 106 overmolding a flexible material on the plurality of flaps 60 to form a flexible connection 66, 68, 70 between adjacent ones of the flaps 60. This flexible connection 66, 68, 70 between adjacent ones of the flaps 60 therefore connects the flaps 60 together to allow the segmented cover 22 to move as a single unit. As shown in FIGS. 6-8, each of the flaps 60 has a generally rectangular cross-section defining an inner surface 62 and an outer surface 64 opposite thereof Two sides 76 extend between the inner surface 62 and the outer surface 64 to complete the generally rectangular cross-section,

As illustrated in the embodiment shown in FIG. 6, the step of overmolding a flexible material on the plurality of flaps 60 to form a flexible connection 66, 68, 70 between adjacent ones of the flaps 60 may include affixing the flexible material on the outer surface 64 of the flaps 60.

As illustrated in the embodiment shown in FIG. 7, the step of overmolding a flexible material on the plurality of flaps 60 to form a flexible connection 66, 68, 70 between adjacent ones of the flaps 60 may include affixing the flexible material on the inner surface 62 of the flaps 60.

As illustrated in the embodiment shown in FIG. 7, each of the flaps 60 may also include a rib 74 extending generally transversely from the inner surface 62. Furthermore, the step of overmolding a flexible material on the plurality of flaps 60 to form a flexible connection 66, 68, 70 between adjacent ones of the flaps 60 may include affixing the flexible material on the inner surface 62 of the flaps 60 and between the ribs 74 thereof.

As illustrated in the embodiment shown in FIG. 8, the step of overmolding a flexible material on the plurality of flaps 60 to form a flexible connection 66, 68, 70 between adjacent ones of the flaps 60 may include affixing the flexible material between the sides 76 of the flaps 60. As shown in FIG. 8, the flexible material may not contact the inner surface 62 of the flaps 60. As also shown in FIG. 8, the flexible material may not contact the outer surface 64 of the flaps 60.

The method 100 may also include 108 removing the plurality of flaps 60 from the overmolding as a segmented cover 22. After the step of 106 overmolding a flexible material on the plurality of flaps 60, the flexible material should be allowed to set by cooling and/or by chemical action before being subjected to excessive forces that could cause it to be damaged. In other words, a time delay may be required after overmolding the segmented cover 22 before it is removed from the overmolding and/or before it is mounted in the housing 24 of the head-up display unit 20.

The method 100 may also include 110 mounting the segmented cover 22 to a housing 24 of the head-up display unit 20. The step of 110 mounting the segmented cover 22 to the housing 24 may include placing the segmented cover 22 within a track 42, which guides the segmented cover 22 in predetermined locations in both the closed position covering the aperture 28, as shown in FIG. 1, and in the opened position uncovering the aperture 28, as shown in FIG. 2. The step of mounting the segmented cover 22 to the housing 24 may also include connecting an opening mechanism 44 and/or a closing mechanism 52 to the segmented cover 22.

Obviously, many modifications and variations of the present invention are possible in light of the above teachings and may be practiced otherwise than as specifically described while within the scope of the appended claims.

What is claimed is:

1. A head-up display unit having a segmented cover and comprising:
a housing having an upper surface defining an aperture to an interior space and holding a combiner;
the segmented cover movable between a closed position covering the aperture and an opened position uncovering the aperture to allow the combiner to protrude therethrough;
the segmented cover including a plurality of flaps of rigid material each having a generally rectangular elongated profile and a generally rectangular cross-section, and with the flaps being disposed adjacent and parallel to one another;
a flexible connection between adjacent ones of the flaps to allow the segmented cover to be rolled cylindrically into the opened position;
the flaps of the segmented cover defining an inner surface facing the interior space of the housing with the segmented cover in the closed position and defining an outer surface opposite the inner surface.

2. The head up display unit having a segmented cover as set forth in claim 1, wherein the flexible connection includes a first layer of flexible material affixed to the outer surface of the flaps and defining a smooth exterior surface of the segmented cover.

3. The head-up display unit having a segmented cover as set forth in claim 2, wherein the first layer of flexible material is overmolded onto the outer surface of the flaps.

4. The head-up display unit having a segmented cover as set forth in claim 1, wherein the flexible connection includes a second layer of flexible material affixed to the inner surface of the flaps.

5. The head-up display unit having a segmented cover as set forth in claim 4, wherein the second layer of flexible material is overmolded onto the inner surface of the flaps.

6. The head-up display unit having a segmented cover as set forth in claim 1, wherein the inner surface each of the plurality of flaps includes a rib extending transversely therefrom.

7. The head-up display unit having a segmented cover as set forth in claim 1, wherein the ribs are integrally formed with the flaps of rigid material.

8. The head-up display unit having a segmented cover as set forth in claim 1, wherein the flexible connection includes a webbing of flexible material affixed between adjacent ones of the flaps.

9. The head-up display unit having a segmented cover as set forth in claim 8, wherein the webbing of flexible material is overmolded between adjacent ones of the flaps of the segmented cover.

10. The head-up display unit having a segmented cover as set forth in claim 8 wherein the webbing of flexible material does not contact the inner surface or the outer surface of the flaps.

11. The head-up display unit having a segmented cover as set forth in claim 1, wherein the combiner is movable between a storage position within the housing and an operational position extending through the aperture.

12. The head-up display unit having a segmented cover as set forth in claim 1, further including an opening mechanism to move the segmented cover from the closed position to the opened position.

13. The head-up display unit having a segmented cover as set forth in claim 12, wherein the opening mechanism includes a first spool attached to a first end of the segmented cover for pulling the segmented cover to the opened position.

14. The head-up display unit having a segmented cover as set forth in claim 1, further including a closing mechanism to move the segmented cover to the closed position.

15. The head-up display unit having a segmented cover as set forth in claim 14, wherein the closing mechanism includes a second spool attached to a second end of the segmented cover for pulling the segmented cover to the opened position.

16. A method of constructing a segmented cover for a head-up display unit comprising:
molding a plurality of flaps of a rigid material, with each of the flaps having a generally rectangular elongated shape;
aligning the plurality of flaps parallel to one another;
overmolding a flexible material on the plurality of flaps to form a flexible connection between adjacent ones of the flaps;
removing the plurality of flaps from the overmolding as a segmented cover; and
mounting the segmented cover to a housing of the head-up display unit.

17. The method of constructing a segmented cover for a head-up display unit as set forth in claim 16, wherein each of the flaps has a generally rectangular cross-section defining an inner surface and an outer surface opposite thereof; and
wherein the step of overmolding a flexible material on the plurality of flaps to form a flexible connection between adjacent ones of the flaps includes affixing the flexible material on the outer surface of the flaps.

18. The method of constructing a segmented cover for a head-up display unit as set forth in claim 16, wherein each of the flaps has a generally rectangular cross-section defining an inner surface and an outer surface opposite thereof; and
wherein the step of overmolding a flexible material on the plurality of flaps to form a flexible connection between adjacent ones of the flaps includes affixing the flexible material on the inner surface of the flaps.

19. The method of constructing a segmented cover for a head-up display unit as set forth in claim 16, wherein each of the flaps has a generally rectangular cross-section defining an inner surface and an outer surface opposite thereof; and
wherein each of the flaps includes a rib extending generally transversely from the inner surface; and
wherein the step of overmolding a flexible material on the plurality of flaps to form a flexible connection between adjacent ones of the flaps includes affixing the flexible material on the inner surface of the flaps and between the ribs thereof.

20. The method of constructing a segmented cover for a head-up display unit as set forth in claim 16, wherein each of the flaps has a generally rectangular cross-section defining an inner surface and an outer surface opposite thereof and two sides extending between the inner surface and the outer surface; and
wherein the step of overmolding a flexible material on the plurality of flaps to form a flexible connection between adjacent ones of the flaps includes affixing the flexible material between the sides of the flaps.
